(19) United States
(12) Patent Application Publication
(10) Pub. No.: US 2018/0349561 A1
(43) Pub. Date: Dec. 6, 2018

(54) METHOD AND SYSTEM FOR SAFE MEDICATION DISPENSING

(71) Applicant: Russell Dean Lecamus, Magnolia, TX (US)

(72) Inventor: Russell Dean Lecamus, Magnolia, TX (US)

(21) Appl. No.: 15/611,620

(22) Filed: Jun. 1, 2017

(51) Int. Cl. G06F 19/00; A61J 7/00; A61J 7/04

(52) U.S. Cl. CPC G06F 19/3462; A61J 7/0076; A61J 7/0481; A61J 7/0427; A61J 7/0409; A61J 7/0454; A61J 7/0418

(57) ABSTRACT

A method and system of safe medication dispensing includes a smart medication container that includes a sensor and a signal transmitter and a smartphone that includes a processor, memory, local storage, and a signal receiver. A software application on the patient's smartphone inputs one or more of the patient's medications including the dosage, dosage schedule, and number of doses on hand. The software application alerts the patient to take a specific medication according to the medication's dosage schedule. The sensor senses when the patient opens the smart medication container and the signal transmitter transmits a status signal to the smartphone indicating the status of the container. Upon receiving the status signal, the software application updates the patient's dosage schedule. The software application may prompt the patient for refills, to log, or to report the taking of the medication to a third-party monitor.

### BACKGROUND OF THE INVENTION

Prescription and over-the-counter medications are critically important to the treatment and prevention of disease and other medical conditions. To be effective, the patient must take the proper dosage of the appropriate medication in accordance with the specified dosage schedule. When a patient is hospitalized, medication protocols are typically administered by medical professionals who monitor the patient for compliance. However, patients that are not hospitalized or otherwise supervised are prone to dangerous medication errors. For many, such as the elderly, those with degenerative memory loss, and those with mental health issues, the ability to consistently take their medication, in the proper dosage, and on the proper dosage schedule is diminished. These at-risk patients may forget to take a dose, may accidentally take multiple doses, or may even take the wrong medication or combination of medications.

The fragmentation of the healthcare system further complicates the efficacy of, and heightens the risks associated with, medication protocols. Most patients see a primary care physician and several medical specialists, each of which may independently prescribe a course of treatment, including medication. Because there is little to no coordination between different medical professionals, the potentially adverse interactions associated with polypharmacy varies from countervailing to potentially fatal. A recent study by the Center for Disease Control and Prevention suggested that nearly 60 percent of Americans are taking at least 1 medication on a daily basis and nearly 20 percent are taking more than 5 different medications. These patients typically also take over the counter medications, increasing the risk for potentially adverse interactions. With increased life expectancy among an aging population, the risk associated with medication errors presents an ongoing and substantial challenge to the healthcare industry.

### BRIEF SUMMARY OF THE INVENTION

According to one aspect of one or more embodiments of the present invention, a non-transitory computer readable medium includes software instructions that, when executed by a processor, perform a method of safe medication dispensing. The method includes inputting one or more of a patient's medications, where for each medication the input data may include one or more of a dosage, a dosage schedule, and a number of doses on hand. A patient may be alerted to take a specific medication of the patient's medications according to the specific medication's dosage schedule. A status signal confirming that a smart medication container containing the specific medication has been opened may be received, indicating that the patient has opened the smart medication container and taken the medication. The patient's dosage schedule for the specific medication may be updated.

According to one aspect of one or more embodiments of the present invention, a safe medication dispensing system includes a smart medication container having a sensor and a signal transmitter and a smartphone having a processor, memory, local storage, and a signal receiver. The sensor may sense when the smart medication container is opened and the signal transmitter may transmit a status signal to the smartphone indicating the status of the container. The smartphone may receive the status signal and update a status corresponding to a dosing schedule of a medication in a software application.

Other aspects of the present invention will be apparent from the following description and claims.

### BRIEF DESCRIPTION OF THE DRAWINGS

FIG. 1 shows a computing system in accordance with one or more embodiments of the present invention.

FIG. 2 shows a smart medication container in accordance with one or more embodiments of the present invention.

FIG. 3 shows a safe medication dispensing system in accordance with one or more embodiments of the present invention.

FIG. 4 shows input medication information of a safe medication dispensing system in accordance with one or more embodiments of the present invention.

FIG. 5 shows a method of safe medication dispensing in accordance with one or more embodiments of the present invention.

FIGS. 6A, 6B, and 6C shows an alert display, a confirmation display, and a reporting display of a software application of a safe medication dispensing system in accordance with one or more embodiments of the present invention.

### DETAILED DESCRIPTION OF THE INVENTION

One or more embodiments of the present invention are described in detail with reference to the accompanying figures. For consistency, like elements in the various figures are denoted by like reference numerals. In the following detailed description of the present invention, specific details are set forth in order to provide a thorough understanding of the present invention. In other instances, well-known features to one of ordinary skill in the art are not described to avoid obscuring the description of the present invention.

While life expectancy has increased among the aging population, many elderly patients continue to live independently or in minimally supervised facilities, such as assisted living homes, well into their 70s and 80s where they alone are responsible for taking their medication. Because of polypharmacy, degenerative memory loss, and other mental health issues, medication errors are on the rise and can have potentially fatal consequences. As such, there have been numerous solutions proposed to assist unsupervised patients in taking their medication correctly.

Conventional solutions include everything from simple pill boxes to custom medication packages made for a specific patient. For example, the most common solution includes simple pill boxes that include a container for each day of the week. The patient places the appropriate medication for a given day in the container for that specific day. While this solution is sufficient for many patients, it requires the patient to populate the containers of the pill box correctly, it does not alert the patient when it is time to take a medication, it does not confirm or validate that the patient has taken a medication, it does not comprehend the fact that some patients take different medications at different times of the same day, it does not allow for logging, reporting, and monitoring of the patient's compliance, and the risk for medication errors remains. On the other end of the spectrum, some pharmacies offer custom medication packages made for a specific patient. The pharmacy creates personalized medications packages, where all of the patient's medications for that day are placed, so that the patient simply has to open a single package and take the medication placed therein on a daily basis. While this removes the burden of correctly populating the container from the patient, the burden is shifted to the pharmacy and the risk for medication errors remain. And, similar to daily pill boxes, it does not alert the patient when it is time to take a medication, it does not confirm or validate that the patient has taken a medication, it does not comprehend the fact that some patients take different medications at different times of the same day, and it does not allow for logging, reporting, and monitoring of the patient's compliance.

Accordingly, in one or more embodiments of the present invention, a method and system of safe medication dispensing helps at-risk patients to take their medications, in the proper dosage, and at the correct frequency, in accordance with their doctor's instructions. A patient may enter pertinent details about the patient's medications into a software application. The application may optionally validate the input with an internal or external database, and may prompt the patient to confirm the medication, the dosage, and the dosage schedule. The application may optionally determine if there are any potentially adverse interactions by cross-referencing the patient's combinations of medications with an internal or external database. As such, all of the patient's medications may be entered into, aggregated, and maintained within the application which may generate a master dosing schedule for all medications. The application alerts, or reminds, patients when to take a specific medication at the proper time and in the right amount. The application may optionally validate the patient's compliance by receiving a status signal from a smart medication container, confirming with the patient, photographing the patient's compliance, videoing the patient's compliance, logging the patient's compliance within the application or externally, and reporting that the patient has taken their medication to one or more third-party monitors. In addition, the application may optionally remind the patient when a refill is necessary and may even facilitate directly, or through a third-party, the placing of a refill order.

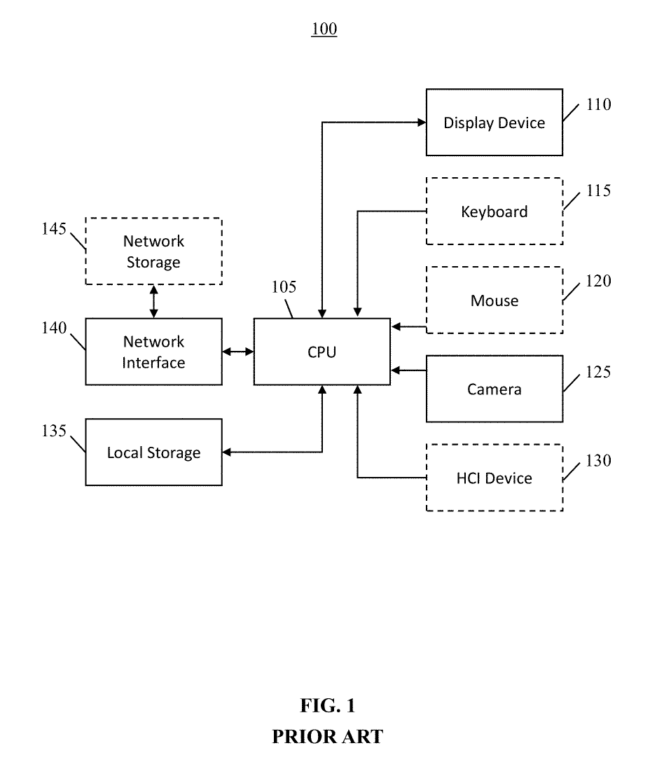

FIG. 1 shows a computing system 100 in accordance with one or more embodiments of the present invention. Computing system 100 may include one or more printed circuit boards or flexible circuits (not shown) on which one or more processors 105 and system memory (not shown) may be disposed. Each of the one or more processors 105 may be a single-core processor or a multi-core processor. Multi-core processors typically include a plurality of processor cores disposed on the same physical die or a plurality of processor cores disposed on multiple die that are disposed within the same mechanical package.

Computing system 100 may include one or more input/output devices such as, for example, a display device 110, a keyboard 115, a mouse 120, a camera 125, or any other human-computer interface device 130. The one or more input/output devices may be discrete or integrated into computer 100. Display device 110 may be a touch screen that includes a touch sensor configured to sense touch. A touch screen enables a user to control various aspects of computing system 100 by touch or gestures. For example, a user may interact directly with objects depicted on display device 110 by touch or gestures that are sensed by the touch sensor and treated as input by computer 100.

Computing system 100 may include one or more local storage devices 135. Local storage device 135 may be a solid-state memory device, a solid-state memory device array, a hard disk drive, a hard disk drive array, or any other non-transitory computer readable medium. Local storage device 135 may be integrated into computer 100. Computing system 100 may include one or more interface devices 140 that provide a network, wireless, or point-to-point communications interface to computer 100. The interface 140 may be Ethernet, Wi-Fi, WiMAX, Fibre Channel, Bluetooth, Bluetooth Low-Energy (“BLE”), Radio Frequency Identification (“RFID”), Near-Field Communications (“NFC”), or any other network, wireless, or point-to-point interface suitable to facilitate networked, wireless, and/or point-to-point communications.

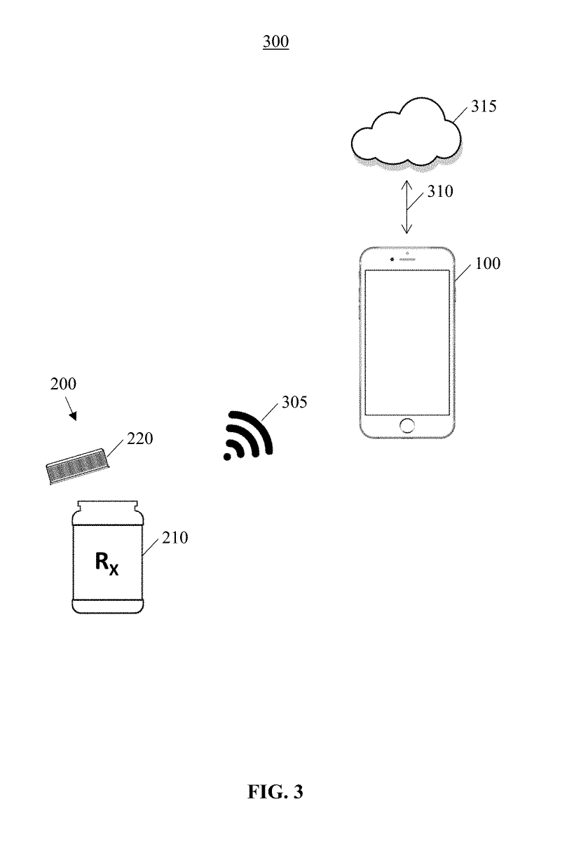

Computing system 100 may include one or more network-attached storage devices 145 in addition to, or instead of, one or more local storage devices 135. Network-attached storage device 145 may be a solid-state memory device, a solid-state memory device array, a hard disk drive, a hard disk drive array, or any other non-transitory computer readable medium. Network-attached storage device 145 may not be collocated with computer 100 and may be accessible to computer 100 via one or more interfaces provided by one or more interface devices 140 and may include cloud-based storage (e.g., 315 of FIG. 3).

One of ordinary skill in the art will recognize that computer 100 may preferably be a smartphone, a smartwatch, a tablet, a stand-alone device, or any other mobile device, but could also be a cloud-based server, a server, a workstation, a desktop, a laptop, a netbook, a kiosk, or any other type of computing system in accordance with one or more embodiments of the present invention.

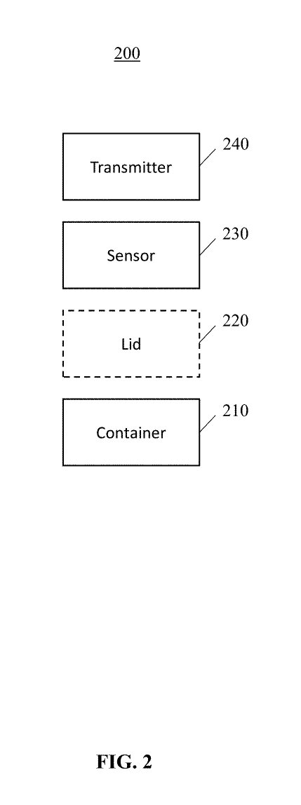

FIG. 2 shows a smart medication container 200 in accordance with one or more embodiments of the present invention. In certain embodiments, smart medication container 200 may be a container for doses of medication, such as, for example, capsules, tablets, or other traditional medications. In other embodiments, smart medication container 200 may be a container for non-traditional medications such as, for example, injectable medications such as insulin. One of ordinary skill in the art will recognize that smart medication container 200 may be any type or kind of container, in any shape or size, which may be used to store medication and send a status signal to a computing system (e.g., 100 of FIG. 1), such as, for example, a smartphone (not shown), when smart medication container 200 is accessed, in accordance with one or more embodiments of the present invention.

Smart medication container 200 may include a container 210, an optional lid 220, a sensor 230, and a transmitter 240. Optional lid 220 may be optional depending on the type or kind of container 210 used. For example, a traditional medication bottle, such as that obtained from a pharmacy, may utilize an optional lid 220 whereas other types of containers 210 may not require a discrete lid 220. Sensor 230 may be configured to detect when smart medication container 200 has been accessed (container 210 opened or optional lid 220 removed). Upon detection by sensor 230, transmitter 240 may be configured to transmit a wireless status signal indicating that container 200 has been accessed (container 210 opened or optional lid 220 removed). One of ordinary skill in the art will recognize that sensor 230 and transmitter 240 may be discrete components or may be integrated depending on the type, kind, and configuration of sensor 230 and transmitter 240, smart medication container 200, and computing system (e.g., 100 of FIG. 1) used in accordance with one or more embodiments of the present invention. Similarly, one of ordinary skill in the art will recognize that sensor 230 and transmitter 240 may be disposed in, on, or as part of any one or more portions of smart medication container 200, so long as they are capable of sensing that container 200 has been accessed and then transmitting a status signal indicating the same.

In one or more embodiments of the present invention, sensor 230 may be a magnetic sensor, a reed switch sensor, a solenoid sensor, a contact sensor, a proximity sensor, a microelectromechanical (“MEM”) sensor, a pressure sensor, an electromagnetic sensor, a electromechanical sensor, a film sensor, a capacitive sensor, an inductive sensor, a resistive sensor, a transponder, combinations thereof, or any other type or kind of switch or sensor, which may be used to detect when smart medication container 200 has been accessed (container 210 opened or optional lid 220 removed). For example, a magnetic or reed switch sensor may open or close a circuit based on how close it is to a magnet. Similarly, a contact sensor may open or close a circuit based on making or breaking electrical contact. Regardless of the type or kind of sensor 230 used, sensor 230 may be configured such that when container 210 is closed or optional lid 220 is secured in place, sensor 230 may be in a first state indicating that the container 200 is closed and when container 210 is opened or optional lid 220 is removed, sensor 230 may be in a second state indicating that the container 200 is opened. One of ordinary skill in the art will recognize that the type, kind, and configuration of sensor 230 used may vary based on an application or design in accordance with one or more embodiments of the present invention.

When container 200 is accessed, transmitter 240 may transmit a status signal to a computing system (e.g., 100 of FIG. 1), such as, for example, a smartphone (not shown), where a software application (not shown) executing thereon may take further actions based on receipt of the status signal. In certain embodiments, the status signal may simply indicate that the container 200 has been accessed. In other embodiments, the status signal may include one or more of a container 200 identifier, a time or date stamp, an indication that the container 200 has been opened, and an indication that the container 200 has been closed. One of ordinary skill in the art will recognize that the data transmitted as part of the status signal may vary based on an application or design in accordance with one or more embodiments of the present invention.

In one or more embodiments of the present invention, transmitter 240 may transmit the status signal (not shown) via Ethernet, Wi-Fi, WiMAX, Fibre Channel, Bluetooth, BLE, RFID, NFC, or any other network, wireless, or point-to-point protocol suitable to facilitate networked, wireless, and/or point-to-point communications. Transmitter 240 may be active or passive depending on the type or kind of communications interface used. One of ordinary skill in the art will recognize that the type, kind, and configuration of transmitter 240 used may vary based on an application or design in accordance with one or more embodiments of the present invention. Once the status signal is received by a computing system (e.g., 100 of FIG. 1), such as, for example, a smartphone (not shown), the software application (not shown) executing thereon may take further actions as discussed in more detail herein.

FIG. 3 shows a safe medication dispensing system 300 in accordance with one or more embodiments of the present invention. A safe medication dispensing system 300 may include a computing system 100 and one or more smart medication containers 200. Computing system 100 may preferably be a smartphone, a smartwatch, a tablet, a stand-alone device, or any other mobile device, but could be any other type of computing system in accordance with one or more embodiments of the present invention. Computing system 100 may include a non-transitory computer readable medium (not shown) that executes a software application (not shown) that performs a method of safe medication dispensing as discussed in more detail herein.

Each smart medication container 200 may include one or more containers 210 that may vary in shape, size, and configuration in accordance with one or more embodiments of the present invention. In certain embodiments, smart medication container 200 may also include an optional lid 220 to close certain types or kinds of containers 210, such as, for example, a traditional pill bottle. When smart medication container 200 is accessed, a transmitter (e.g., 240 of FIG. 2) may transmit a status signal (not shown) via a network, wireless, or point-to-point communication 305 to computing system 100 and the software application (not shown) executing thereon may take further actions based on receipt of the status signal (not shown). The software application (not shown) executing on computing system 100 may send or receive data 310 to another computing system (e.g., 100 of FIG. 1) or cloud-based storage device (e.g., 145 of FIG. 1), herein collectively referred to as third-party 315, for further actions as part of the method of smart medication dispensing discussed in more detail herein.

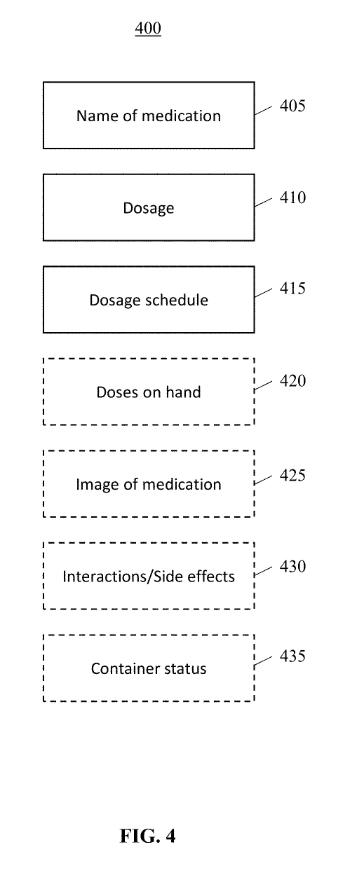

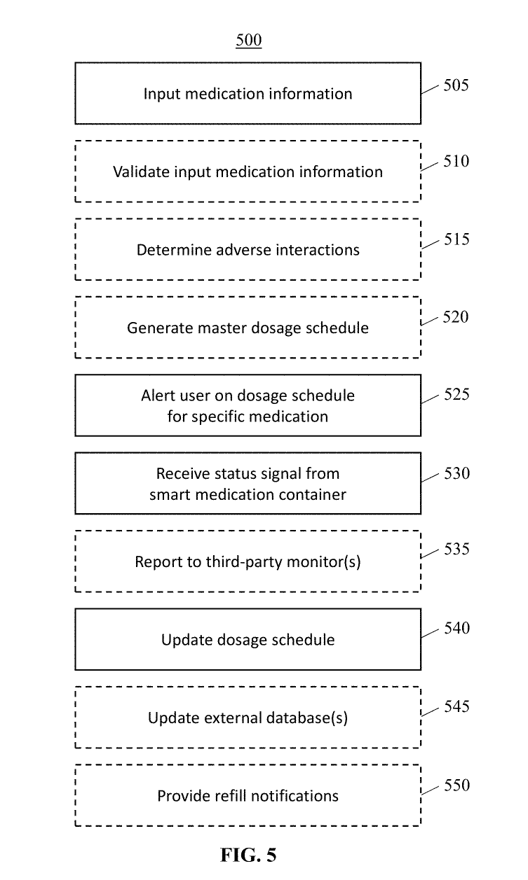

FIG. 4 shows input medication information 400 of a safe medication dispensing system 300 in accordance with one or more embodiments of the present invention. As noted above, safe medication dispensing system (e.g., 300 of FIG. 3) may include a computing system (e.g., 100 of FIG. 4) and a software application (not shown) configured to execute thereon that performs a method of safe medication dispensing (see, e.g., FIG. 5 and accompanying text). The software application (not shown) may be configured with a specific patient's medication information to enable the software application (not shown) to perform the method. In one or more embodiments of the present invention, the configuration of the software application (not shown) may be manual, automatic, supervised, or combinations thereof.

In certain embodiments, a patient may input their medication information 400 into the software application (not shown) manually. For each medication, the patient may enter one or more of the name of the medication 405, the dosage 410, and the dosage schedule 415. The patient may optionally enter the prescribing doctor, the prescribing pharmacy, a number of doses 420 on hand, take, or select from a list, a photo of the medication 425, enter, or select from a list, potential interactions or side effects 430, and enter a status 435 of the smart medication container (e.g., 200 of FIG. 2). The patient may input this information for each medication that the patient takes and desires to track via the software application. One of ordinary skill in the art will recognize that other information may be input in accordance with one or more embodiments of the present invention.

In other embodiments, a patient's medication information 400 may be input into the software application (not shown) automatically. For example, the software application (not shown) may include a discovery mode where the patient's computing system (e.g., 100 of FIG. 1) receives a discovery signal (not shown) from each smart medication container (e.g., 200 of FIG. 2) that includes the name of the medication 405, the dosage 410, and the dosage schedule 415. The smart medication container (e.g., 200 of FIG. 2) may optionally transmit the prescribing doctor, the prescribing pharmacy, the number of doses 420 on hand, a photo of the medication 425, a list of potential interactions or side effects 430, and a status 435 of the smart medication container (e.g., 200 of FIG. 2). Alternatively, the software application (not shown) or an externally accessed database or application (not shown) may provide a photo of the medication 425 and a list of potential interactions or side effects 430 upon receiving the discovery signal (not shown). This information may be input for each medication that the patient takes and desires to track via the software application. One of ordinary skill in the art will recognize that other information may be input in accordance with one or more embodiments of the present invention.

In still other embodiments, a patient or caretaker may input the patient's medication information 400 into the software application (not shown) with supervision. For each medication, the patient or caretaker may enter one or more of the name of the medication 405, the dosage 410, and the dosage schedule 415. The patient or caretaker may optionally enter the prescribing doctor, the prescribing pharmacy, the number of doses 420 on hand, take, or select from a list, a photo of the medication 425, enter, or select from a list, potential interactions or side effects 430, and enter a status 435 of the smart medication container (e.g., 200 of FIG. 2). In a supervisory mode, the software application (not shown) may optionally validate this input information 400 through a third-party monitor. This information may be input for each that the patient takes and desires to track via the software application. One of ordinary skill in the art will recognize that other information may be input in accordance with one or more embodiments of the present invention.

FIG. 5 shows a method of safe medication dispensing 500 in accordance with one or more embodiments of the present invention. As noted above, a safe medication dispensing system (e.g., 300 of FIG. 3) may include a computing system (e.g., 100 of FIG. 1) and a software application (not independently illustrated) configured to execute thereon that performs the method of safe medication dispensing 500. In certain embodiments, a non-transitory computer readable medium of the computing system (e.g., 100 of FIG. 1) may comprise software instructions, constituting the software application, that, when executed by a processor of the computing system, performs the method of safe medication dispensing 500 discussed herein. In other embodiments, the method of safe medication dispensing 500 may be performed by a software application, a safe medication dispensing system, or combinations thereof.

In step 505, a patient's medication information may be input into the software application as described with respect to FIG. 4. For each medication, the input may include one or more of the name of the medication, the dosage, and the dosage schedule. The input may optionally include the prescribing doctor, the prescribing pharmacy, the number of doses on hand, a photo of the medication, a list of potentially adverse interactions or side effects, and a status of a smart medication container. In one or more embodiments of the present invention, the configuration of the software application may be manual, automatic, supervised, or combinations thereof. One of ordinary skill in the art will recognize that other information may be input in accordance with one or more embodiments of the present invention.

In step 510, the medication information input in step 505 may optionally be validated by the software application. As an additional safety precaution, validation may sanity check, or validate, the inputted medication information. In one or more embodiments of the present invention, the validation may be manual, automatic, supervised, or combinations thereof. In manual validation, the patient may be prompted to verify the medication information input manually. For example, the software application may, for each medication, display a picture of the medication on a display of the computing system and prompt the patient to verify the appearance of the medication, the dosage, and the dosage schedule. In automatic validation, the software application may, for each medication, validate the input with an internal or external database. For example, the software application may verify that the input falls within acceptable ranges specified by an internal or external database automatically without requiring further action by the patient. In certain embodiments, initial validation may be provided by an internal database of the software application and further validation may be provided by an external database on a remote computing system. For example, the name of the medication, the dosage, and the dosage schedule may be validated by verifying that the dosage and the dosage schedule falls within established values for that specific medication. If the medication and validated ranges of input are not within an internal database of the software application, the software application may query an external database to validate the range of input. Further validation may verify the inputted medication information with the prescribing doctor, the prescribing pharmacy, or an external database or application. In supervised validation, one or more third-party monitors, such as, for example, a caretaker, the prescribing doctor, the prescribing pharmacy, or other third-party may validate the inputted medication information. In certain embodiments, there may be more than one third-party monitor. The software application may transmit (e.g., network, wireless, point-to-point, email, and text) various aspects of the medication information to the third-party's independent computing system or cloud-based computing resource to perform the supervisory validation. One of ordinary skill in the art will recognize that various combinations that include aspects of manual, automatic, and supervised validation may be used in accordance with one or more embodiments of the present invention.

In step 515, the software application may optionally determine if there are any potentially adverse interactions between the medications input as part of the patient's medication information. The software application may maintain a list of potentially adverse interactions between medications in an internal database, query an external database if there are no interactions in the internal database, query an external database initially, or initially check the internal database and then query the external database as an additional safety precaution. In the event there is a potentially adverse interaction, the software application may alert the patient and advise that they consult with their pharmacist and prescribing doctor or doctors before taking the medications. The software application may disallow continued use of the application until the alert is cleared or the medication protocol is changed to one that does not include potentially adverse interactions and report the potentially adverse interactions to a third-party monitor.

In step 520, the software application may optionally generate a master dosage schedule for the patient's medications. The master dosage schedule may identify all of the patient's medications, the dosages, and the dosage schedules in an aggregated schedule that may be used to alert the patient when to take a specific medication for all medications tracked. For each medication, the dosage schedule may include one or more times of day to take the specific medication and the frequency of taking the medication. The software application may be configured to generate a daily master dosage schedule, a take with food master dosage schedule, a morning and evening master dosage schedule, or an independent master dosage schedule, depending on the dosage schedules of each medication, or combinations thereof. The daily master dosage schedule may include a list of all medications to be taken once a day. The take with food master dosage schedule may include a list of all medications to be taken with one or more meals throughout the day. The morning and evening master dosage schedule may include a list of medications to be taken in the morning and a list of medications to be taken in the evening. The independent master dosage schedule may include a list of medications to be taken, each one given their own, potentially unique, dosage schedule as inputted in step 505. One of ordinary skill in the art will recognize that the master dosage schedule may vary in accordance with one or more embodiments of the present invention. In the absence of a master dosage schedule, a dosage schedule for each medication input may include a next medication date and time that is scheduled independently of other medications.

In step 525, the software application may alert the patient to take a specific medication of the patient's medications according to the specific medication's dosage schedule on a specific day and time. The alert may include one or more of an alert display on the display of the patient's computing system, playing an alert sound, and vibrating the computing system. In certain embodiments, the alert may include displaying an image of the specific medication that the patient is supposed to take on the display of the patient's computing system.

In step 530, the software application may, by way of the patient's computing system, receive a status signal confirming that the smart medication container containing the specific medication has been accessed. As discussed above with respect to FIGS. 2 and 3, when the smart medication container containing the specific medication that is the subject of the alert is accessed, the smart medication container may transmit a status signal to the software application by way of the patient's computing system. The status signal may include an identifier of the smart medication container and an indicator of whether the smart medication container has been accessed. If the smart medication container accessed is not the smart medication container containing the specific medication that is the subject of the alert, the patient may be warned that they opened the wrong medication container as an additional safety precaution.

In step 535, the software application may optionally confirm, independently, or through a third-party monitor, that the patient has taken the specific medication that is the subject of the alert. In certain embodiments, the software application may simply prompt the patient to confirm that they have taken the specific medication after receipt of the status signal from the corresponding smart medication container. In other embodiments, the software application may prompt the patient to photograph or video the taking of the specific medication for verification by a third-party monitor after receipt of the status signal from the corresponding smart medication container.

In photograph embodiments, the patient may be prompted to take a photograph of the medication with a camera of the patient's computing system to verify the proper medication was taken and photograph the patient placing the medication in their mouth to verify they took the medication. The photographs may then be reported to one or more third-party monitors charged with monitoring the patient's compliance with their medication protocols. In video embodiments, the patient may be prompted to show the medication to the camera and video their taking of the specific medication. The video may then be reported to one or more third-party monitors charged with monitoring the patient's compliance with their medication protocols.

The photographs or video may be transmitted, through an interface of the patient's computing system, to the third-party's computing system or a cloud-based storage for retrieval by the third-party monitor. The third-party monitor may be a caretaker, the prescribing doctor, the prescribing pharmacy, or other third-party charged with the task of monitoring the patient's compliance with the medication protocol. The third-party monitor may, after verifying compliance, send a verification signal to the software application indicating that the monitor has verified that the patient took the specific medication in compliance with their medication protocol.

In step 540, the software application may update the dosage schedule for the specific medication taken. Specifically, after receipt of the status signal, the software application may log that the specified dosage that was the subject of the alert has been taken, clear the alert, schedule the next dosage, if it was not previously already scheduled, and update the number of doses on hand, if tracked.

In step 545, the software application may update one or more external databases. A log of the patient's compliance with their medication protocols may be maintained on a third-party computing system to protect the data contained in the patient's software application. After receipt of the status signal or confirmation by the patient or a third-party monitor of the patient's compliance, the log may be updated indicating that the patient took a dosage of the specific medication. The one or more external databases may include the name of the medication, the dosage, the dosage schedule, and the patient's history of taking the medication, for each of the patient's medications.

In step 550, the software application may optionally provide the patient with notification that refills may be required. In embodiments where the medication information includes the number of doses on hand, the software application may track the number of doses remaining and may alert the patient when refills are required. In certain embodiments, the software application may facilitate the ordering of refills through a third-party.

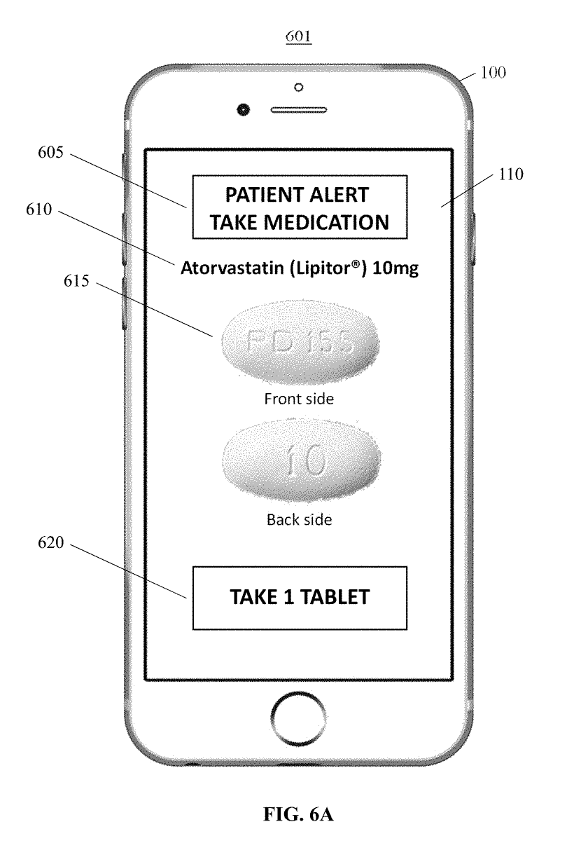

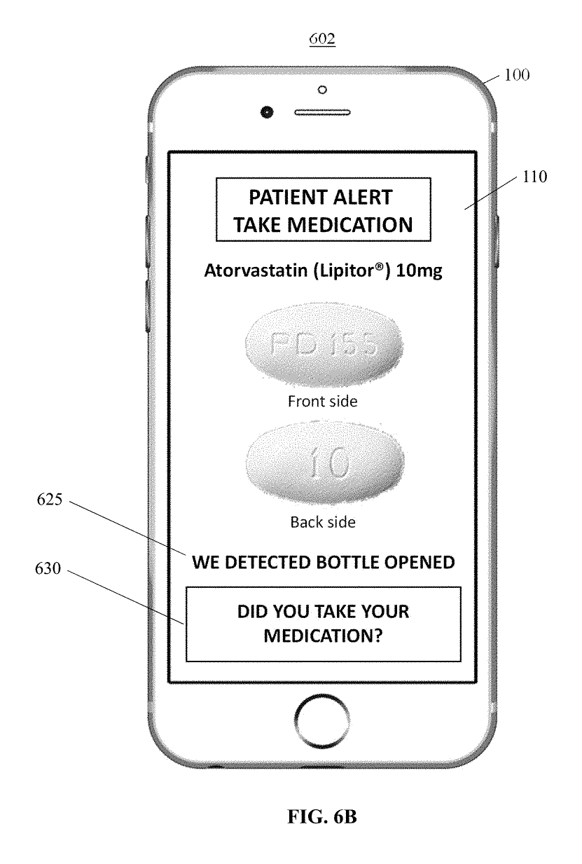

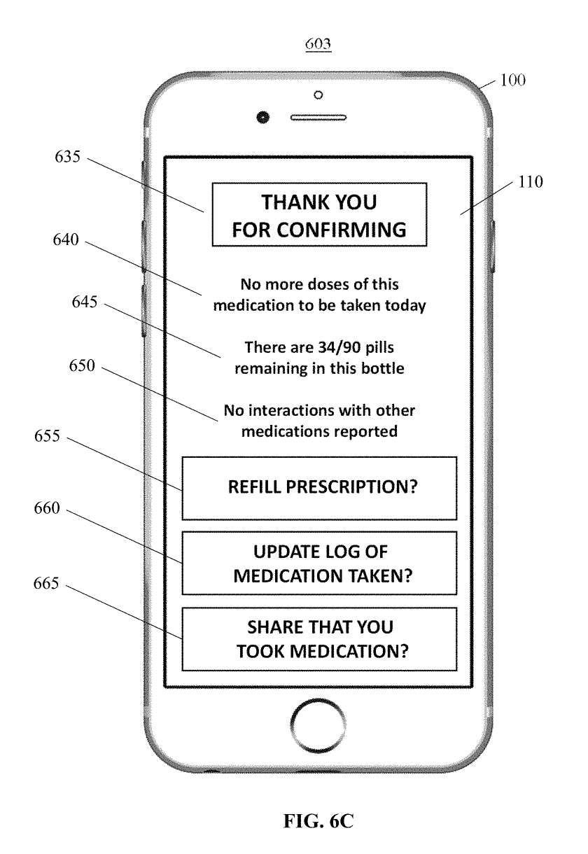

FIG. 6A shows an alert display 601 of a software application of a safe medication dispensing system (e.g., 300 of FIG. 3) in accordance with one or more embodiments of the present invention. When the software application wants to alert the patient that it is time to take a specific medication, the application may display an alert on the display 110 of the patient's computing system 100. The alert may include one or more of an alert message 605 alerting the patient that it is time to take the specific medication, a name 610 of the specific medication to be taken, an image 615 of the specific medication to be taken, and an instruction 620 to take the proper dosage. In addition, the alert display 601 may be accompanied by one or more of the playing of an alert sound and vibrating the computing system 100. One of ordinary skill in the art will recognize that the alert display 601 may vary based on an application or design in accordance with one or more embodiments of the present invention.

Continuing, FIG. 6B shows a confirmation display 602 of a software application of a safe medication dispensing system (e.g., 300 of FIG. 3) in accordance with one or more embodiments of the present invention. Upon receipt of the status signal, the software application may display a confirmation message 625 confirming that the smart medication container containing the specific medication to be taken has been accessed. As discussed above, the software application may include a confirmation prompt 630 that may prompt the patient to independently, or through a third-party monitor, confirm that they have taken the specific medication and complied with the medication protocol. One of ordinary skill in the art will recognize that the confirmation display 602 may vary based on an application or design in accordance with one or more embodiments of the present invention.

Continuing, FIG. 6C shows a reporting display 603 of a software application of a safe medication dispensing system (e.g., 300 of FIG. 3) in accordance with one or more embodiments of the present invention. After confirming that the patient has taken the specific medication, the software application may display a reporting display 603. The reporting display 603 may include one or more of a confirmation message 635, an indicator 640 when the next dose is to be taken, a number 645 of remaining doses on hand, an advisement 650 regarding interactions, a prompt 655 to refill prescriptions, a log option 660 to update a log of medications taken, and a share option 665 to report that the patient took the specific medication to a third-party monitor, send an email, a text message, or post to social media. One of ordinary skill in the art will recognize that the displays shown are merely exemplary and are in no way intended to limit the claimed invention.

Advantages of one or more embodiments of the present invention may include one or more of the following:

In one or more embodiments of the present invention, a method and system of safe medication dispensing helps at-risk patients to take their medications, in the proper dosage, and at the correct frequency, in accordance with their doctor's instructions.

In one or more embodiments of the present invention, a method and system of safe medication dispensing helps at-risk patients to comply with their medication protocols and their doctor's instructions.

In one or more embodiments of the present invention, a method and system of safe medication dispensing reminds at-risk patients when to take their medication and logs their compliance with their medication protocol.

In one or more embodiments of the present invention, a method and system of safe medication dispensing inputs pertinent details about the patient's medications, prompts the patient to confirm the input, optionally validates the input with an internal or external database, and prompts the patient to confirm the medication, the dosage, and the dosage schedule. As such, all of a patient's medications may be aggregated and maintained within the software application that governs the dosing schedule for all medications.

In one or more embodiments of the present invention, a method and system of safe medication dispensing may determine if there are any potentially adverse interactions between or among the various medications that the patient takes. The potentially adverse interactions may be determined by cross-referencing the patient's combination of medications for potentially adverse interactions with a database. The database may be internal to the software application or an externally accessible database. If the software application determines there is a potentially adverse interaction, the application may alert the patient advising of the potentially adverse interaction.

In one or more embodiments of the present invention, a method and system of safe medication dispensing reports that a patient has taken a specific medication to a third-party monitor. The software application may confirm the patient has taken the medication by receipt of the status signal from the smart medication container or a camera on a smartphone validating the medication by image or recording a video of the patient taking the medication and providing access to the same to the third-party monitor.

While the present invention has been described with respect to the above-noted embodiments, those skilled in the art, having the benefit of this disclosure, will recognize that other embodiments may be devised that are within the scope of the invention as disclosed herein. Accordingly, the scope of the invention should be limited only by the appended claims.

What is claimed is:

1. A non-transitory computer readable medium comprising software instructions that, when executed by a processor, perform a method of safe medication dispensing comprising:
inputting one or more of a patient's medications, wherein for each medication the input data includes a dosage, a dosage schedule, and optionally a number of doses on hand;
alerting a patient to take a specific medication of the patient's medications according to the specific medication's dosage schedule;
receiving a status signal confirming that a smart medication container containing the specific medication has been opened; and
updating the dosage schedule for the specific medication.

2. The non-transitory computer readable medium of claim 1, further comprising:
for each medication input, displaying a picture of the medication on a display of the patient's computing device and prompting the patient to verify an appearance of the medication, the dosage, and the dosage schedule.

3. The non-transitory computer readable medium of claim 1, further comprising:
for each medication input, validating the medication, the dosage, and the dosage schedule with a database.

4. The non-transitory computer readable medium of claim 1, further comprising:
determining if there are any potential adverse interactions between the patient's inputted medications; and
alerting the patient if it is determined there are potentially adverse interactions.

5. The non-transitory computer readable medium of claim 4, wherein determining if there are any potentially adverse interactions comprises cross-referencing the patient's combination of medications for potentially adverse interactions with a database.

6. The non-transitory computer readable medium of claim 1, further comprising:
prompting the patient to confirm that they have taken the specific medication after receipt of the status signal.

7. The non-transitory computer readable medium of claim 1, further comprising:
prompting the patient to photograph a medication retrieved from the smart medication container to confirm that the retrieved medication is the specific medication that is the subject of the alert.

8. The non-transitory computer readable medium of claim 1, further comprising:
prompting the patient to photograph themselves placing the specific medication in their mouth to confirm that they have taken the specific medication.

9. The non-transitory computer readable medium of claim 1, further comprising:
prompting the patient to video a medication retrieved from the smart medication container to confirm that the retrieved medication is the specific medication that is the subject of the alert.

10. The non-transitory computer readable medium of claim 1, further comprising:
prompting the patient to video themselves placing the specific medication in their mouth to confirm that they have taken the specific medication.

11. The non-transitory computer readable medium of claim 1, further comprising:
updating the number of doses on hand after receipt of the status signal.

12. The non-transitory computer readable medium of claim 1, further comprising:
clearing the alert to take the specific medication after receipt of the status signal.

13. The non-transitory computer readable medium of claim 1, further comprising:
displaying a refill notification when the number of doses on hand for the medication falls below a predetermined threshold.

14. The non-transitory computer readable medium of claim 1, further comprising:
reporting that the patient has taken the specific medication to a third-party monitor after receipt of the status signal.

15. The non-transitory computer readable medium of claim 1, further comprising:
updating a log of medication taken after receipt of the status signal.

16. The non-transitory computer readable medium of claim 1, further comprising:
updating an external database after receipt of the status signal.

17. The non-transitory computer readable medium of claim 1, wherein alerting comprises displaying an alert and an image of the specific medication to be taken on a display of the patient's computing device.

18. The non-transitory computer readable medium of claim 1, wherein receiving the status signal comprises receiving an identifier of the smart medication container and an indicator of the opened status of the smart medication container.

19. The non-transitory computer readable medium of claim 1, wherein updating the patient's dosage schedule comprises logging that the patient has taken the specific medication after receipt of the status signal and setting an alert for a next dosage of the specific medication according to its dosage schedule.

20. A safe medication dispensing system comprising:
a smart medication container comprising a sensor and a signal transmitter; and
a smartphone comprising a processor, memory, local storage, and a signal receiver,
wherein the sensor senses when the smart medication container is opened and the signal transmitter transmits a status signal to the smartphone indicating the status of the container, and
wherein the smartphone receives the status signal and updates a status corresponding to a dosing schedule of a medication in a software application.
